(19) United States
(12) Patent Application Publication
(10) Pub. No.: US 2008/0186453 A1
(43) Pub. Date: Aug. 7, 2008

(54) REAR PROJECTION DEVICE

(76) Inventors: Wei-Szu Lin, Hsin-Chu (TW); Wen-Hao Hsu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/838,216

(22) Filed: Aug. 13, 2007

(30) Foreign Application Priority Data
Feb. 5, 2007 (TW) 096202200

(51) Int. Cl. G03B 21/22

(52) U.S. Cl. 353/74

(57) ABSTRACT

A rear projection apparatus includes a display housing, a first screwing device, and an optical engine. The display housing has a fourth hole and a first fixing component. The optical engine includes a covering and a plurality of optical components. The plurality of optical components is fixed inside the covering. The covering is fixed on the housing directly. A first hole and a third hole are formed on the covering. The first screwing device is inserted into the third hole and the fourth hole. The first fixing component is inserted into the first hole. The plurality of optical components projects an image beam into an image on a screen.

### BACKGROUND OF THE INVENTION

1. Field of the Invention

The present invention relates to a rear projection device, and more particularly, to a rear projection device with an optical engine combined with a display housing directly.

2. Description of the Prior Art

Please refer to FIG. 1 and FIG. 2. FIG. 1 is a schematic view of a rear projection apparatus 10 in the prior art. FIG. 2 is an exploded drawing of the rear projection apparatus 10 in the prior art. The rear projection apparatus 10 includes an optical engine 12, a display housing 42, and a board 40. The optical engine 12 includes a covering 14 and an optical module 15 disposed inside the covering 14. For the optical engine utilizing Digital Light Processing (DLP) technology, a light source 16 of the optical module 15 includes a parabolic reflector 161. Light beams 18, generated by the light source 16 and reflected by the parabolic reflector 161, pass through a converging lens 20, a color wheel 22, an integration rod 24 to uniform the light beams 18, a condenser lens 26, a stop 28, a relay lens 30, and finally converge into a total reflection prism system 32 which is capable of reflecting the light beams 18 with a reflection mirror 321 to a digital micro-mirror device (DMD) 34. The digital micro-mirror device 34 modulates the light beams 18 into image beams and selectively reflects the image beams through the total reflection prism system 32 and further through a projection lens 36 and finally onto a screen 38. The display housing 42 includes a bottom surface 422 and a first lateral surface 424. The first lateral surface 424 is disposed on a lateral side of the bottom surface 422. A plurality of holes 426 is formed on a lateral surface opposite to the first lateral surface 424. A plurality of protrusion components 428 is disposed on the first lateral surface 424. Holes 402, 404 are formed on later sides of the board 40.

For assembling the rear projection apparatus 10, the covering 14 of the optical engine 12 is assembled on the board 40 with screws first. Then the board 40 is assembled inside the display housing 42 by inserting the protrusion components 428 into the holes 402 and screwing the board 40 on the display housing 42 by means of screwing devices inserted into the holes 426, 404. However the cost and the assembly hour increase due to the board 40 as a connection interface of the optical engine 12 and the display housing 42. The precision and the reliability of the assembly reduce due to deformation of the board 40. Furthermore, the board 40 increases the size and the weight of the rear projection apparatus 10 resulting in increasing packaging and freightage charges.

### SUMMARY OF THE INVENTION

A rear projection device with an optical engine combined with a display housing directly for solving the above-mentioned problem is provided.

According to the claimed invention, a rear projection apparatus includes a display housing, a first screwing device, and an optical engine. The display housing has a fourth hole and a first fixing component. The optical engine includes a covering and a plurality of optical components. The plurality of optical components is fixed inside the covering. The covering is fixed on the display housing directly. A first hole and a third hole are formed on the covering. The first screwing device is inserted into the third hole and the fourth hole. The first fixing component is inserted into the first hole. The plurality of optical components projects an image beam into an image on a screen.

Other objectives, features and advantages of the present invention will be further understood from the further technology features disclosed by the present invention wherein there are shown and described preferred embodiments of this invention, simply by way of illustration of modes best suited to carry out the invention.

### BRIEF DESCRIPTION OF THE DRAWINGS

FIG. 1 is a schematic view of a rear projection apparatus in the prior art.

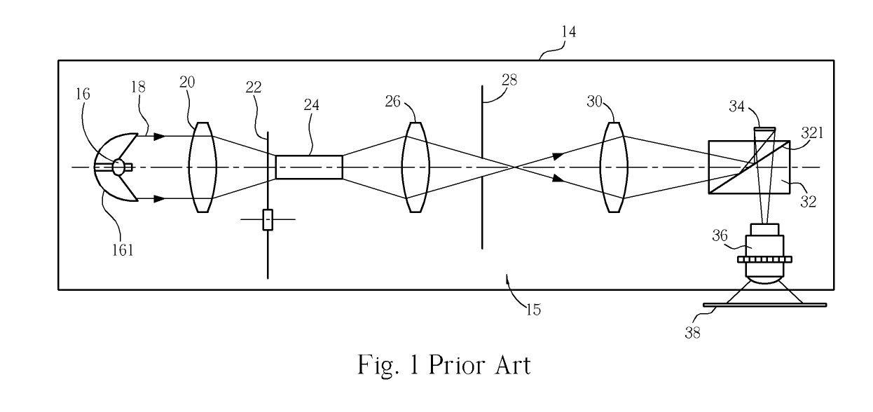

FIG. 2 is an exploded drawing of the rear projection apparatus in the prior art.

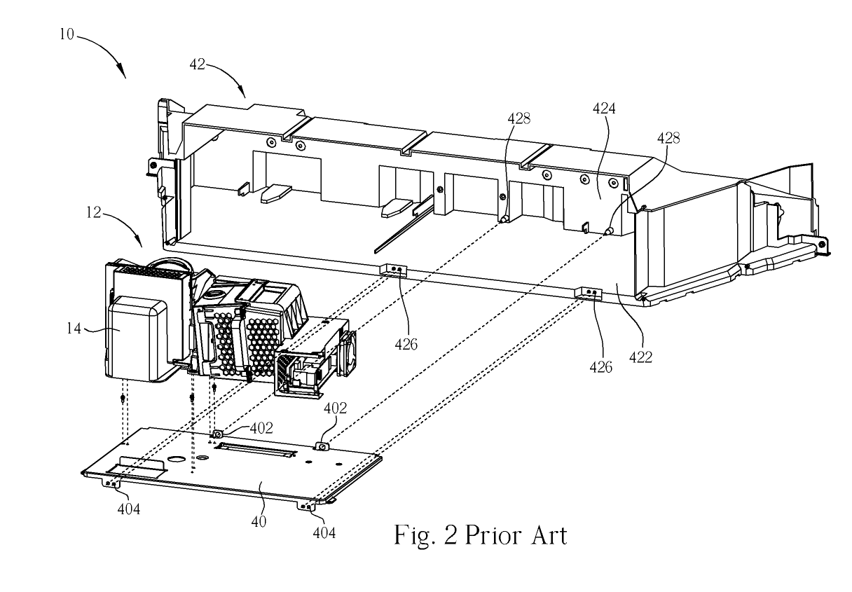

FIG. 3 is a schematic view of a rear projection apparatus of the present invention.

FIG. 4 is an exploded drawing of the rear projection apparatus of the present invention.

FIG. 5 is a schematic drawing of an optical engine of the present invention.

FIG. 6 is a rear view of the optical engine of the present invention.

FIG. 7 is a front view of the optical engine of the present invention.

FIG. 8 is an exploded drawing of a rear projection apparatus according to another embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

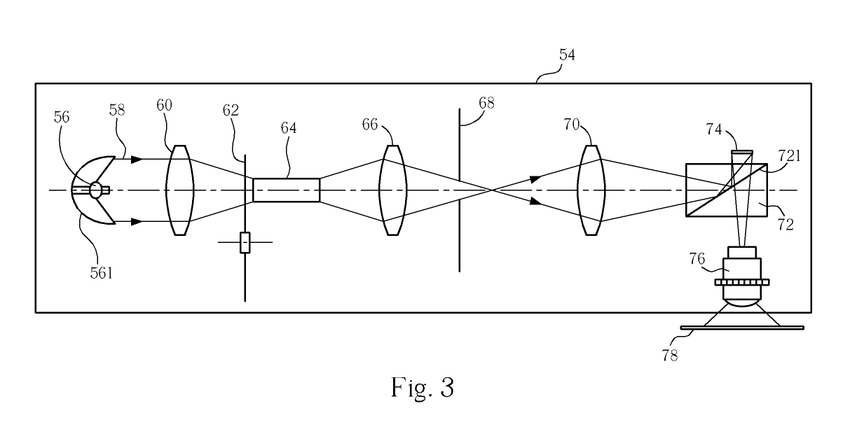

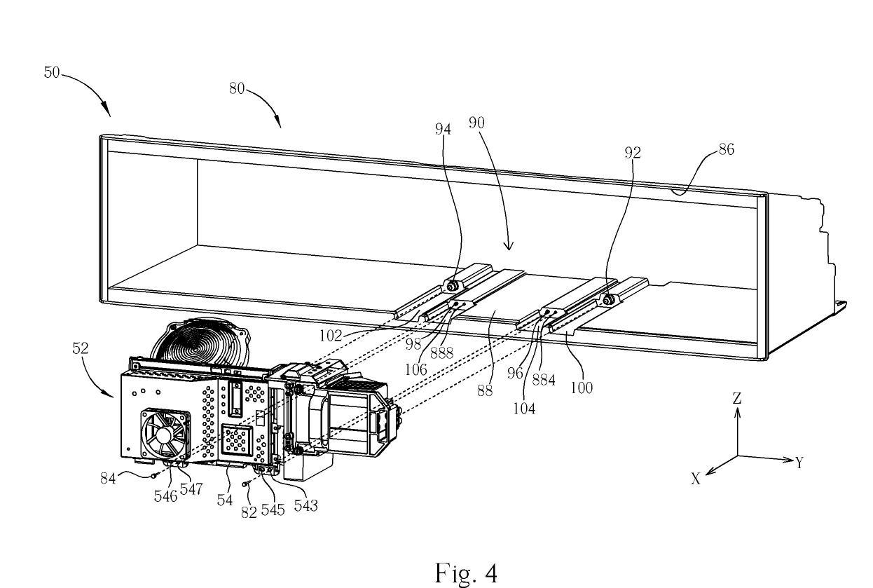

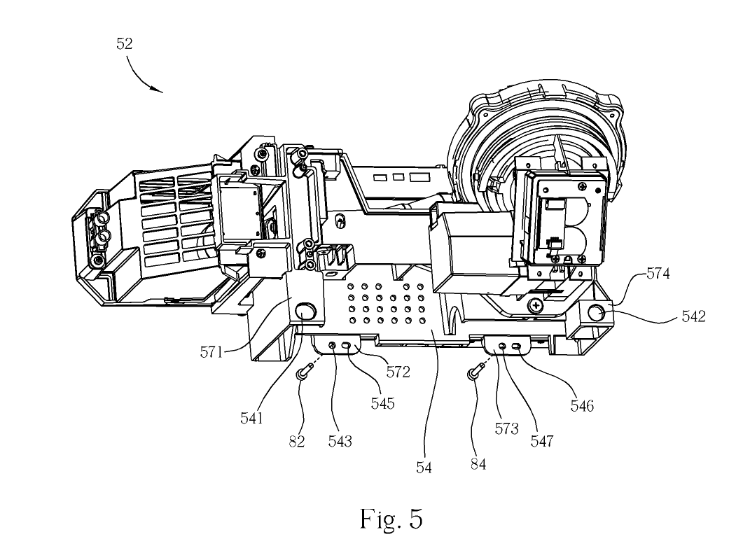

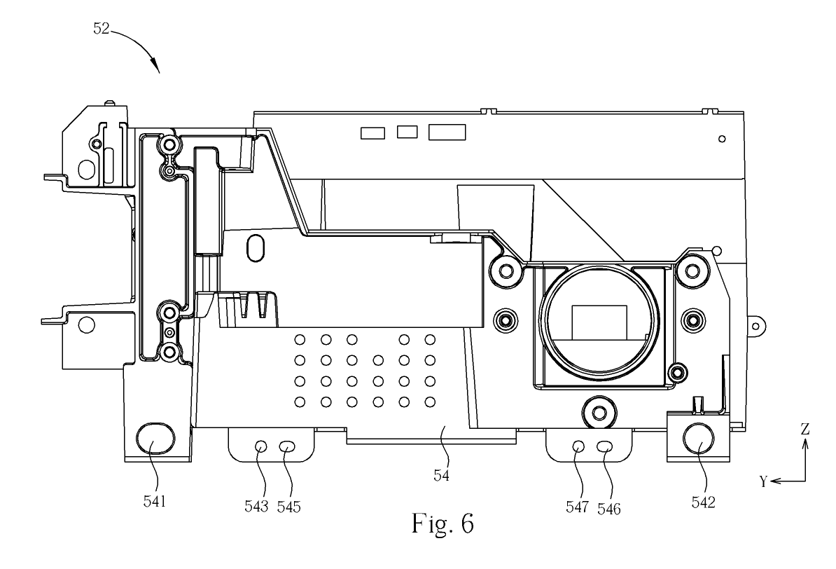

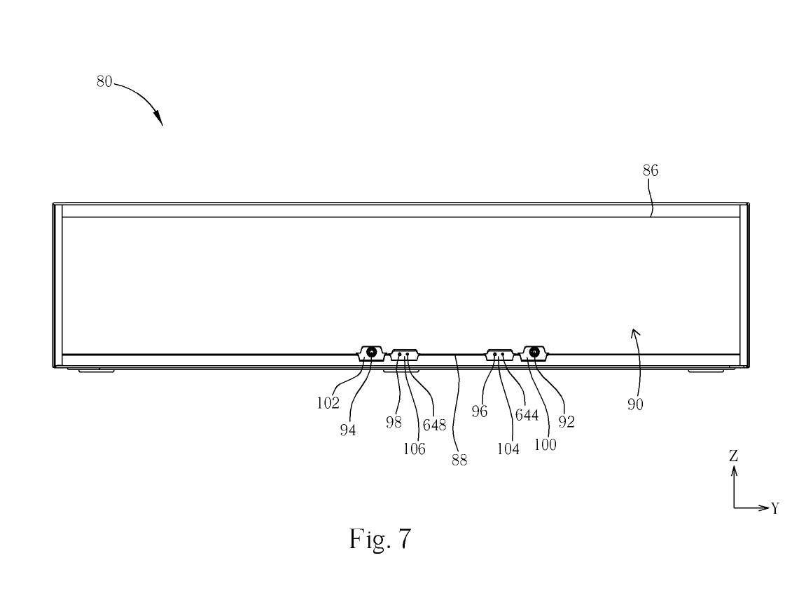

Please refer to FIG. 3 to FIG. 7. The rear projection apparatus 50 includes the optical engine 52, a display housing 80, a first screwing device 82, and a second screwing device 84. The optical engine 52 includes a covering 54 and a plurality of optical components. The covering 54 includes a first protrusion 571, a second protrusion 572, a third protrusion 573, and a fourth protrusion 574. A first hole 541 is formed on the first protrusion 571. A second hole 542 is formed on the fourth protrusion 574. A third hole 543 and a fifth hole 545 are formed on the second protrusion 572. A sixth hole 546 and a seven hole 547 are formed on the third protrusion 573. The second protrusion 572 is disposed between the first protrusion 571 and the third protrusion 573. The third protrusion 573 is disposed between the second protrusion 572 and the fourth protrusion 574. The plurality of optical components is fixed inside the covering 54 directly. The plurality of optical components includes a light source 56, a light valve 74, and a projection lens 76 and is for projecting image beams into an image on a screen 78. For the optical engine utilizing Digital Light Processing (DLP) technology, the plurality of optical components further includes a converging lens 60, a color wheel 62, an integration rod 64, a condenser lens 66, a stop 68, a relay lens 70, and a total reflection prism system 72. The light source 56 includes a parabolic reflector 561. Light beams 58, generated by the light source 56 and reflected by the parabolic reflector 561, pass through the converging lens 60, the color wheel 62, the integration rod 64 to uniform the light beams 58, the condenser lens 66, the stop 68, the relay lens 70, and finally converge into the total reflection prism system 72 which is capable of reflecting the light beams 58 with a reflection mirror 721 to the light valve 74 utilizing a digital micro-mirror device (DMD). The light valve 74 modulates the light beams 58 into image beams and selectively reflects the image beams through the total reflection prism system 72 and further through the projection lens 76 and finally onto the screen 78.

The display housing 80 includes a top surface 86 and a bottom surface 88 opposite to the top surface 86. A space 90 is formed between the top surface 86 and the bottom surface 88. A fourth hole 884 is formed on the bottom surface 88 corresponding to the third hole 543, and a eighth hole 888 is formed on the bottom surface 88 corresponding to the seventh hole 547. The display housing 80 includes a first fixing component 92, a second fixing component 94, a third fixing component 96, and a fourth fixing component 98. The first fixing component 92 is disposed on the bottom surface 88 and is inserted into the first hole 541. The second fixing component 94 is disposed on the bottom surface 88 and is inserted into the second hole 542. The third fixing component 96 is disposed between the first fixing component 92 and the second fixing component 94 on the bottom surface 88 and is inserted into the fifth hole 545. The fourth fixing component 98 is disposed between the second fixing component 94 and the third fixing component 96 on the bottom surface 88 and is inserted into the sixth hole 546. The diameter of each fixing component is less than the diameter of the corresponding hole slightly. The first fixing component 92, the second fixing component 94, the third fixing component 96, and the fourth fixing component 98 are disposed on the bottom surface 88 of the display housing 80 in one-piece molding structure.

A first slot 100, a second slot 102, a third slot 104, and a fourth slot 106 are formed on the bottom surface 88 of the display housing 80. The first slot 100 is disposed on a side of the first fixing component 92. The second slot 102 is disposed on a side of the second fixing component 94. The third slot 104 is disposed on a side of the third fixing component 96 and the fourth hole 884. The fourth slot 106 is disposed on a side of the fourth fixing component 98 and the eighth hole 888. The first slot 100, the second slot 102, the third slot 104, and the fourth slot 106 are formed on the bottom surface 88 of the display housing 80 in one-piece molding structure. The first slot 100 is located at a position corresponding to the first protrusion 571. The second slot 102 is located at a position corresponding to the fourth protrusion 574. The third slot 104 is located at a position corresponding to the second protrusion 572. The fourth slot 106 is located at a position corresponding to the third protrusion 573.

The assembling method of the rear projection apparatus 50 is introduced as follows. First, the first protrusion 571, the second protrusion 572, the third protrusion 573, and the fourth protrusion 574 of the optical engine 52 are inserted into the first slot 100, the third slot 104, the fourth slot 106, and the second slot 102 respectively and then slide into the space 90 inside the display housing 80 in a longitudinal direction (X direction) along the first slot 100, the third slot 104, the fourth slot 106, and the second slot 102 respectively. The width of each protrusion (Y direction) is less than the width of the corresponding slot slightly. After the first protrusion 571, the second protrusion 572, the third protrusion 573, and the fourth protrusion 574 slide to ends of the first slot 100, the third slot 104, the fourth slot 106, and the second slot 102 respectively, the first fixing component 92 is inserted into the first hole 541, the second fixing component 94 is inserted into the second hole 542, the third fixing component 96 is inserted into the fifth hole 545, and the fourth fixing component 98 is inserted into the sixth hole 546 so that the optical engine 52 is positioned in the space 90 and the optical engine 52 is constrained in Y and Z directions. At this time the fourth hole 884 on the bottom surface 88 is aimed at the third hole 543 on the covering 54, and the eighth hole 888 on the bottom surface 88 is aimed at the seven hole 547 on the covering 54. Then the first screwing device 82 is inserted into the third hole 543 and the fourth hole 884, and the second screwing device 84 is inserted into the seventh hole 547 and the eighth hole 888 so as to screw the optical engine 52 inside the display housing 80. The first screwing device 82 and the second screwing device 84 are screws. The optical engine 52 is screwed on the display housing 80 by means of the first and second screwing devices 82 and 84, and therefore it is constrained in X direction.

The numbers of fixing components and corresponding holes, screwing devices and corresponding holes, and slots and corresponding protrusions are not limited to the above-mentioned embodiment. It depends on a design demand. For example, the rear projection apparatus 50 includes three fixing components and three corresponding holes, one screwing device and one corresponding hole, and one slot and one corresponding protrusion.

In addition, after the first protrusion 571, the second protrusion 572, the third protrusion 573, and the fourth protrusion 574 slide to ends of the first slot 100, the third slot 104, the fourth slot 106, and the second slot 102 respectively, the first fixing component 92 is inserted into the first hole 541, and the second fixing component 94 is inserted into the second hole 542, the optical engine 52 is fine tuned to rotate along Y direction so as to adjust an angle of the optical engine 52. Then the angle of the optical engine 52 is fixed by screwing the optical engine 52 on the display housing 80 by means of the first screwing device 82 and the second screwing device 84.

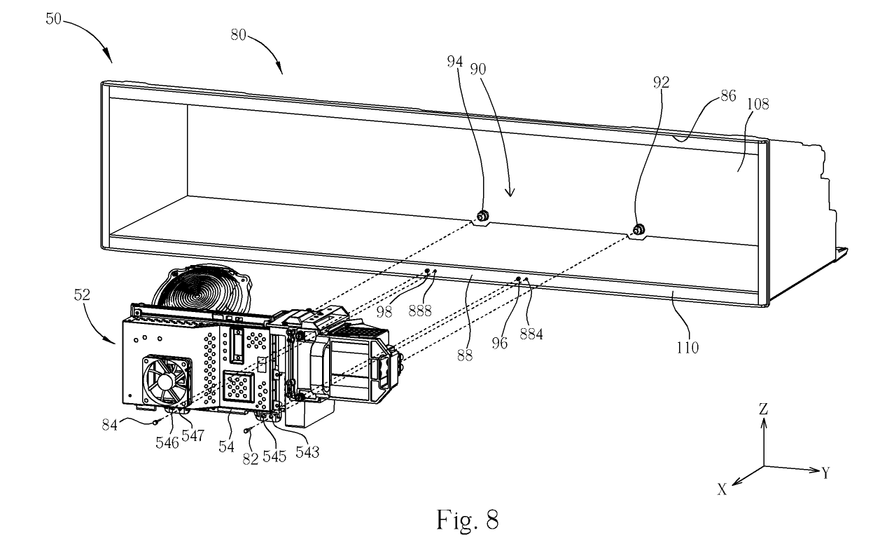

Please refer to FIG. 8, the difference between this embodiment and the above-mentioned embodiment is that the rear projection apparatus 80 includes a first lateral surface 108 and a second lateral surface 110. The first lateral surface 108 is connected to a lateral side of the bottom surface 88, and the second lateral surface 110 is connected to another lateral side opposite to the lateral side of the bottom surface 88. The first fixing component 92 and the second fixing component 94 are disposed on the first lateral surface 108 on the display housing 80. The third fixing component 96, the fourth fixing component 98, the fourth hole 884, and the eighth hole 888 are formed on the second lateral surface 110 on the display housing 80. The fixing components and holes are not limited to dispose on the specific surfaces. It may be disposed on the top surface 86 or other lateral surfaces, and other fixing mechanisms is disposed at the corresponding position, depending on a design demand. The combination of the covering 54 of the optical engine 52 and the display housing 80 is similar to or the same as the above-mentioned embodiment, therefore the detail description thereof will not be illustrated herein.

In contrast to the conventional rear projection apparatus, the optical engine is fixed on the display housing directly of the rear projection apparatus of the present invention so as to reduce the cost and the assembly hour. There is no need to utilize a board as a connection interface of the optical engine and the display housing so as to reduce cost of components. The precision and the reliability of the assembly is increased without utilizing the board. Furthermore, the present invention reduces the size and the weight of the rear projection apparatus resulting in reducing packaging and freightage charges.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A rear projection apparatus comprising:
a display housing having a fourth hole and a first fixing component;
an optical engine disposed inside the display housing, the optical engine comprising:
a covering fixed on the display housing, a first hole and a third hole formed on the covering and the first fixing component inserted into the first hole; and
a plurality of optical components fixed inside the covering for projecting an image beam into an image on a screen; and
a first screwing device inserted into the third hole and the fourth hole and screwed on the display housing.

2. The rear projection apparatus of claim 1 wherein the display housing further comprises:
a top surface; and
a bottom surface opposite to the top surface, wherein
a space is formed between the top surface and the bottom surface and the optical engine is disposed in the space.

3. The rear projection apparatus of claim 2 wherein the display housing further comprises:
a first lateral surface connected to a lateral side of the bottom surface; and
a second lateral surface connected to another lateral side opposite to the lateral side of the bottom surface, wherein the first fixing component is disposed on the first lateral side and the fourth hole is formed on the second lateral side.

4. The rear projection apparatus of claim 2 wherein the first fixing component is disposed on the bottom surface and the fourth hole is formed on the bottom surface.

5. The rear projection apparatus of claim 1 wherein the display housing further comprises at least one slot disposed on the display housing and the covering further comprises a protrusion corresponding to the slot.

6. The rear projection apparatus of claim 1 wherein the plurality of optical components includes a light source, a light valve, and a projection lens.
